(19) United States
(12) Patent Application Publication
(10) Pub. No.: US 2008/0300874 A1
(43) Pub. Date: Dec. 4, 2008

(54) SPEECH SKILLS ASSESSMENT

(75) Inventors: Marsal Gavalda, Sandy Springs, GA (US); John Willcutts, Marietta, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/132,745

(22) Filed: Jun. 4, 2008

Related U.S. Application Data
(60) Provisional application No. 60/941,783, filed on Jun. 4, 2007.

(51) Int. Cl. G10L 15/26; G10L 21/00

(52) U.S. Cl. 704/235; 704/270; 704/E15.045; 704/E15.043

(57) ABSTRACT

An approach to evaluating a person's speech skills includes automatically processing speech of a person and text some or all of which corresponds to the speech. In some examples, a job application procedure includes collecting speech from an applicant, and using text corresponding to the collected speech to automatically assess speech skills of the applicant. The text may include text that is presented to the applicant and the speech collected from the applicant can include the applicant reading the presented text.

### CROSS-REFERENCE TO RELATED APPLICATIONS

This application claims the benefit of U.S. Provisional Application No. 60/941,783, filed Jun. 4, 2007, which is incorporated herein by reference.

This application is also related to U.S. Pat. No. 7,231,351, titled “TRANSCRIPT ALIGNMENT,” issued on Jun. 12, 2007, which is incorporated herein by reference.

### BACKGROUND

This invention relates to automated assessment of speech skills.

Speech skills can be important, for example, in jobs that may require spoken interaction with customers. For example, a telephone call center agent may require good speech skills in order to interact with customers effectively. In some cases, a person may require good speech skills in a number of languages. Speech skills can include, for example, fluency, pronunciation accuracy, and appropriate speaking rate.

One way to evaluate the speech skills of a person is for another person to converse with that person to assess their skills. Another way is to provide the text of a passage to the person, and record the person reading the passage. This recording can later be evaluated by another person to assess the speech skills.

### SUMMARY

In a general aspect, an approach to evaluating a person's speech skills includes automatically processing speech of a person and text corresponding to some or all of the speech.

In another aspect, in general, a job application procedure includes collecting speech from an applicant, and using text corresponding to the collected speech to automatically assess speech skills of the applicant. The text may include text that is presented to the applicant and the speech collected from the applicant can include the applicant reading the presented text.

In another aspect, a computer system provides remote users with an assessment of their speech skills. The computer system can provide services to other parties, for example, as a hosted service to companies assessing the speech skills of job applicants.

Advantages of the approach can include one or more of the following.

An automated screening procedure for speech skills can be performed without requiring another person to listen to speech, either live or from a recording. Because a person is not required, automated systems (e.g., in an employment application kiosk) can be used to perform speech skills assessment that is used for screening purposes.

An automated speech skills assessment can be used to provide an initial ranking of speakers by a skills score. For example, this ranking can be used to select top scoring job applicants.

Other features and advantages of the invention are apparent from the following description, and from the claims.

### DESCRIPTION OF DRAWINGS

FIG. 1 is a block diagram.

FIG. 2 is a text passage.

FIG. 3 is time alignment data for lines of the text passage.

FIG. 4 is a flowchart.

FIG. 5 is a presentation of phoneme scores.

FIG. 6 is a flowchart of an applicant screening system.

FIG. 7 is an applicant screening system.

### DESCRIPTION

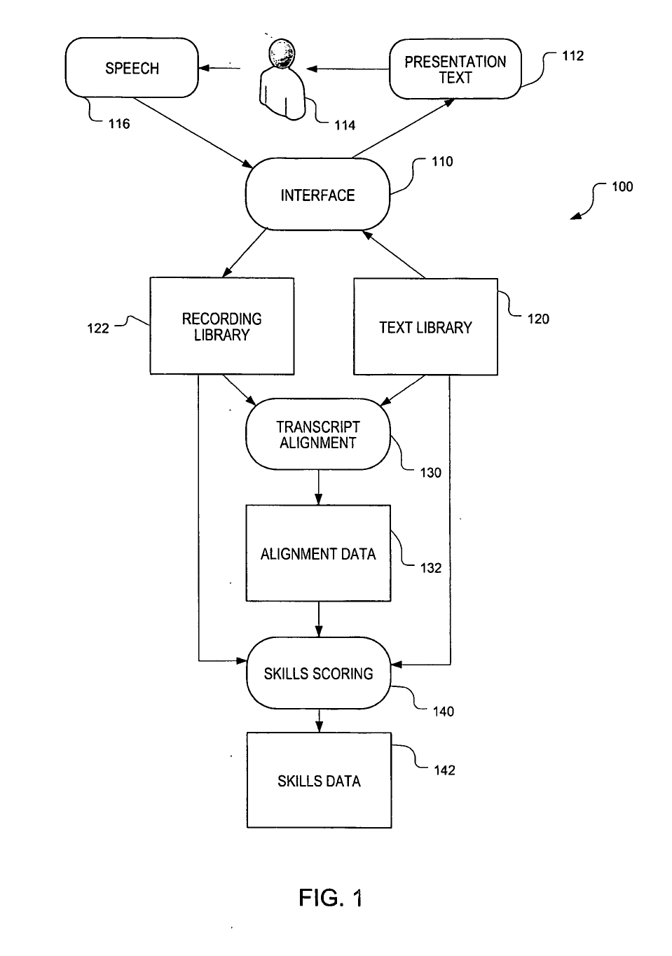

Referring to FIG. 1, an automated speech skills assessment system 100 includes an interface 110 through which a presentation text 112 selected from a text library 120 is presented to a user 114 and through which speech 116 is collected from the user reading the presentation text. The recording is processed immediately or stored in a recording library 122 for further processing. In some examples, the interface is presented at a computer (e.g., a workstation, a kiosk, etc.) having a graphical display as well as an audio input device, such as a microphone or handset. In other examples, the interface is remote such as using a telephone connection between the user and the interface to collect the speech. In such examples, the presentation text may be provided to the user 114 in a hardcopy form before the user interacts with the system.

In order to assess the speech skills of the user 114, the system analyzes the recorded speech in conjunction with the text that was presented to the user. A variety of aspects of the speech input are evaluated in various examples of the system. The aspects can relate to various characteristics of the input that may indicate or be correlated with skill level. For example, words may be missing or incorrectly substituted with other words (i.e., reading errors), the user may restart reading portions of the text, and sections of the text may be omitted. Words may be read accurately, but be mispronounced. Reading rate may be irregular (i.e., not fluent), or may be significantly faster or slower than an average or typical reading rate. Intonation may not be appropriate to the text being read, for example, with pitch not matching a question in the text.

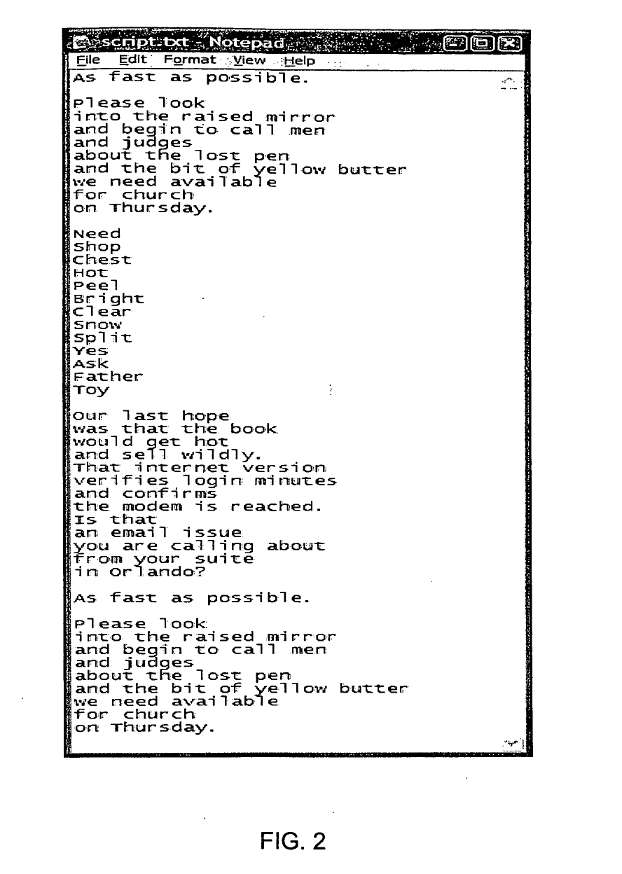

Referring to FIG. 2, an example of presentation text 112 includes paragraphs, isolated words, and isolated sentences. In some example, the entire presentation text is shown to the user 114 on a computer screen. In some embodiments, the text may be shown progressively as the user reads the text. The interface 110 accepts a recording of the user reading the text, for example, as data representing a digitally sampled waveform of an audio microphone signal or as a processed form of such data. In some examples, recordings from a number of different users are stored prior to further analysis of the data, while in some examples, the data for each user is processed immediately after it is received from the user.

As a first step to analysis of the speech, a transcript alignment procedure 130 is used to match the speech recording and the presented text. In some examples, a transcript alignment procedure described in co-pending application Ser. No. 10/384,273, titled “TRANSCRIPT ALIGNMENT,” is used. In some examples, the alignment procedure is robust to substantial reading errors while still identifying portions of the speech input corresponding to sections (e.g., sentences) of the presentation text. The transcript alignment procedure produces alignment data 132, which includes for example, a word-level or phoneme-level time alignment of sections of the presentation text. In some examples, a word or phrase level alignment or time association is first obtained, and then a second pass uses the results of the first pass to determine phoneme level time alignment and in some examples match scores for the individual phonemes.

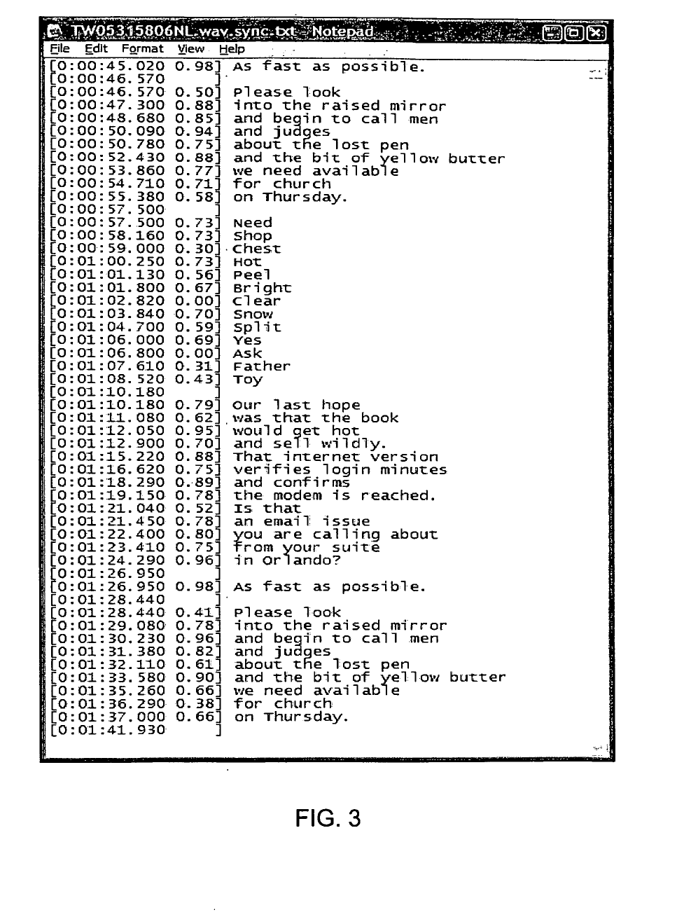

Therefore in some examples, the transcript alignment procedure is robust to portions of the text not being spoken, or being spoken so poorly that they cannot be matched to the corresponding text, and to repetitions and restarts of portions of the text, while still alignment data 132 providing timing information such as overall reading rate, local reading rate for different parts of the text, a degree of variation in reading rate, time alignment indicating the start time and end time of passages, sentences, words, or subword units (e.g., syllables or phonemes). Referring to FIG. 3, time alignment data at the text line level is illustrated for the passage shown in FIG. 2, with a start time and a duration being indicated for each line of the text.

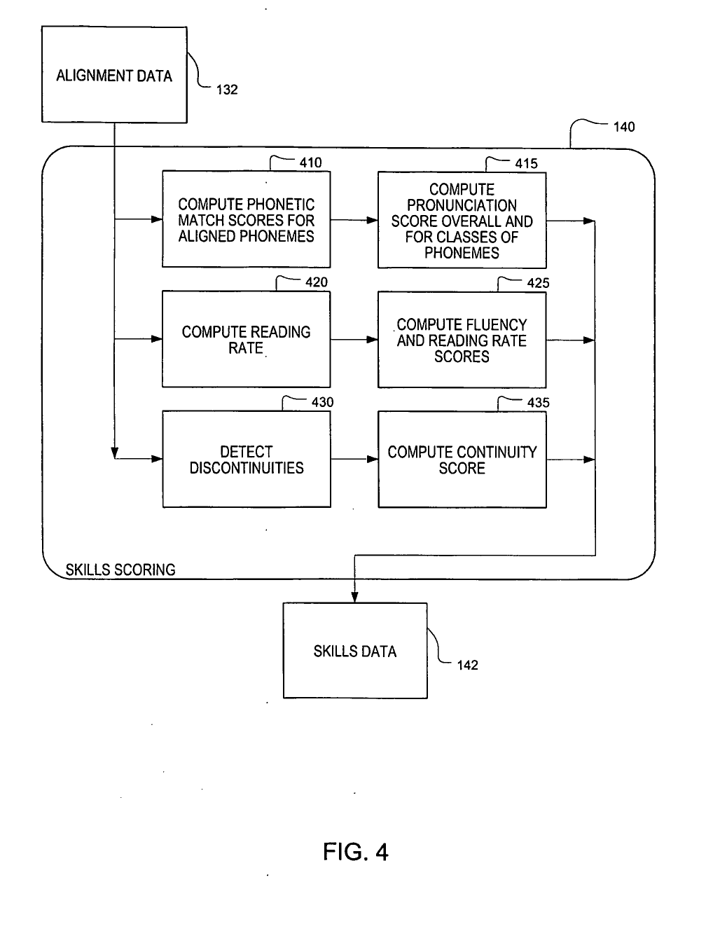

The skills scoring step 140 (see FIG. 1) makes use of the alignment data to score various specific characteristics (i.e., basic skills) based on the recorded audio and the alignment data. These characteristics can include, as examples, one or more of the following, as illustrated in the flowchart shown in FIG. 4.

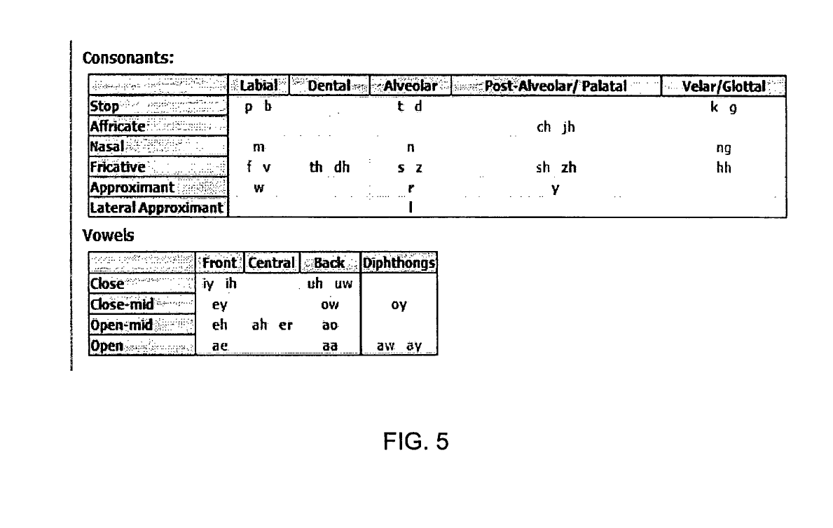

Match scores of one or more granularities of speech units (e.g., sentences, words, syllables, phones) are computed based on the time alignment provided in the alignment data. For example, the match of the speech to phonetic models, for example, based on spectral characteristics is computed for each of the aligned phones (step 410). The scores for the individual units are then combined into an overall pronunciation score, as well as scores for various classes of units. For example, with acoustic match scores computed for aligned phonemes, a score for each of a set of classes of phonemes is computed (step 415). For example, classes of phonemes defined by a place of articulation (e.g., front, back, central, labial, dental, alveolar, post-alveolar/palatal, velar/glottal) and/or degree of stricture (e.g., close, close-mid, open-mid, open, stop, affricate, nasal, fricative, approximant, lateral approximant) are used to determine a score for each class. The scores may be presented in a visual form in two dimensions with the scores indicated by color, as shown in FIG. 5.

A reading rate is computed from the alignment data (step 420). For example, the overall reading rate as compared to an average or typical rate for the passage, as well local reading rate for different portions of the passage and variability in reading rate are calculated. From this, fluency, uniformity of reading rate, or match of reading rate to a model of appropriate reading rate (or reading rate variation) for the text are used to compute fluency and reading rate scores (step 425). Other forms of appropriate prosodies, including appropriate pitch variation, can also be me measured.

Discontinuities in the reading of the text, for example, due to restarts or to skipped portions are detected in the alignment data (step 430). Based on these detections, a score representative of a degree of continuity of the reading (e.g., lack of restarting, missing words, etc.) is computed (step 435).

In some examples, an overall score that combines various individual scores (e.g., pronunciation, fluency, continuity) is computed in the skills scoring module. For example, the overall score provides a way to rank different users of the system.

In some examples of such a system, a match to the phonetic models is scored in step 410 based on a wordspotting approach in which the text is divided into a number of words or phrases, and each word or phrase is associated with a detection score in the speech as well as the detected start and end time for the word or phrase, or is determined to be missing from the transcript in an appropriate sequence with the other words or phrases.

An overall match score is then computed as follows:

$${S}_{p} := \frac{1}{n} {\sum }_{i = 1}^{n} {S}_{i} - α p - β q if {S}_{p} < 1 then {S}_{p} := 1$$

The terms in this expression are defined as follow

n is the number of phrases in the script

sᵢ is the score for the i-th phrase as determined by the word spotting engine

p is the number of missed phonemes (see below), 0≦p≦n

q is the number of bad phonemes (see below), 0≦q≦n

α is the penalty for a missed phoneme, typically 3

β is the penalty for a bad phoneme, typically 1

A missed phoneme is a phoneme that occurs in the script but is not found by the engine when it processes the specific media file. A bad phoneme is a phoneme whose average score falls below a certain threshold.

In some examples of such a system, a fluency score is determined as the ratio of the sum of the durations for each phrase in the script over the entire duration of the script, computed as follows:

$${S}_{F} := \frac{1}{D} {\sum }_{i = 1}^{n} {d}_{i}$$

The terms in this expression are defined as follows:
n is the number of phrases in the script
dᵢ is the duration of the i-th phrase, i.e., the end time of the i-th phrase minus the start time of the i-th phrase, as determined by the word spotting engine
D is the duration of the script, i.e., the end time of the last word in the script minus the start time of the first word in the script, as determined by the Nexidia engine

Skills assessments for the specific skills or characteristics are optionally combined, for example, by a predetermined weighting or by a non-linear combination, to yield an overall skill assessment for the user.

In some examples of such a system, a global score is computed as a linear combination (e.g., weighted average) of pronunciation and fluency scores as follows:

S_{G}=λS_{P}+(1−λ)S_{F}

Where λ is the weighting factor that ranges from 0 to 1, typically ⅔. In other examples, the global score could also be computed as a non-linear function. In some examples, the global score is a linear or non-linear combination of one or more of pronunciation score, fluency score, speaking rate score (derived from but not necessarily equal to the speaking rate), and continuity score.

In some examples, particular portions of a presentation text have been previously identified as being particularly indicative of a user's speech skills. These portions may be identified by a linguistic expert, or may be identified based on statistical techniques. As an example of a statistical technique, a corpus of recorded passages may be associated with skill scores assigned by listeners to the passages. A statistical approach is then used to weight different portions and/or different characteristics to best match the listener generated scores. In this way, certain passages may be more relied upon than others. Rather than weighting, portions of the text to be relied upon are selected based on the listener's data.

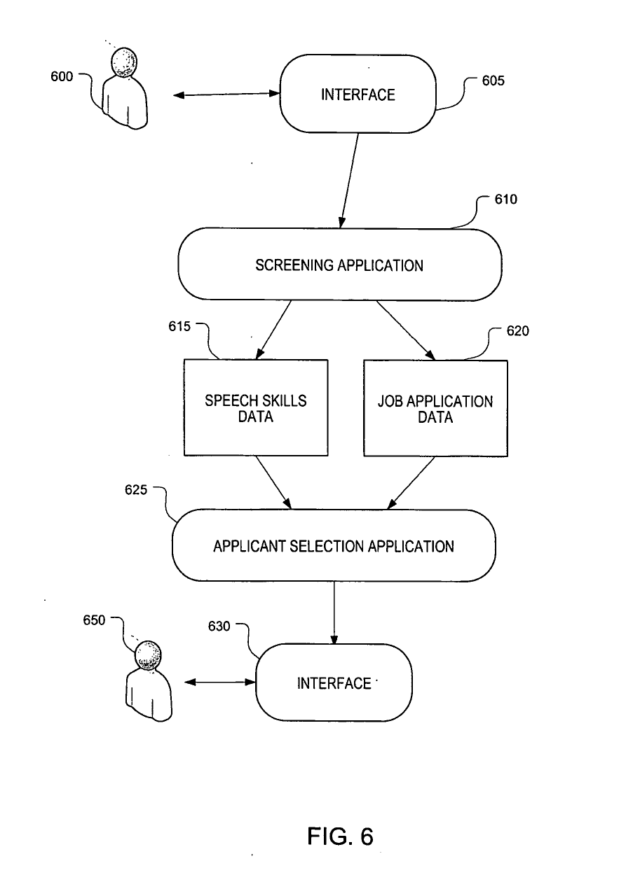

The skills assessment system may be integrated into a number of different overall applications. Referring to FIG. 6, one class of applications relates to evaluation of potential employees, for example, applicants 600 for positions as call center telephone agents. An automated job application system, for example, hosted in a telephone based system or in a computer workstation based system, is used to obtain various information from an applicant through an audio or graphical interface 605 to an applicant screening application 610. As an integral part of the job application that yields job application data 620, the applicant is asked to read a presented text (or other text, such as their answers to other questions). The audio of the applicant is captured for later evaluation, or optionally is evaluated immediately with an on-line system to determine speech skills data 615. In the case of such on-line evaluation, in some examples, the speech skill assessment is used in a screening function based on which the applicant may be given access to additional stages of a job application process (e.g., further automated or personal evaluation stages) if their level of speech skills is sufficiently high.

In some examples, the skills evaluation is performed in a hosted system that provides a service to other entities. For example, a company may contract with a hosted system service to evaluate the speech skills of job applicants to that company. For example, the company may provide the recordings of the job applicants to the service, or provide a way for the job applicants to directly provide their speech to the service. The service may evaluate the speech in a full automated manner using the system described above, or may perform a combination of automated and manual evaluation of the speech. If there is a manual component to the evaluation, data such as the alignment data may be used as an aid to the manual component. For example, portions of the speech corresponding to particular passages in the text may be played to a listener that evaluates the skills.

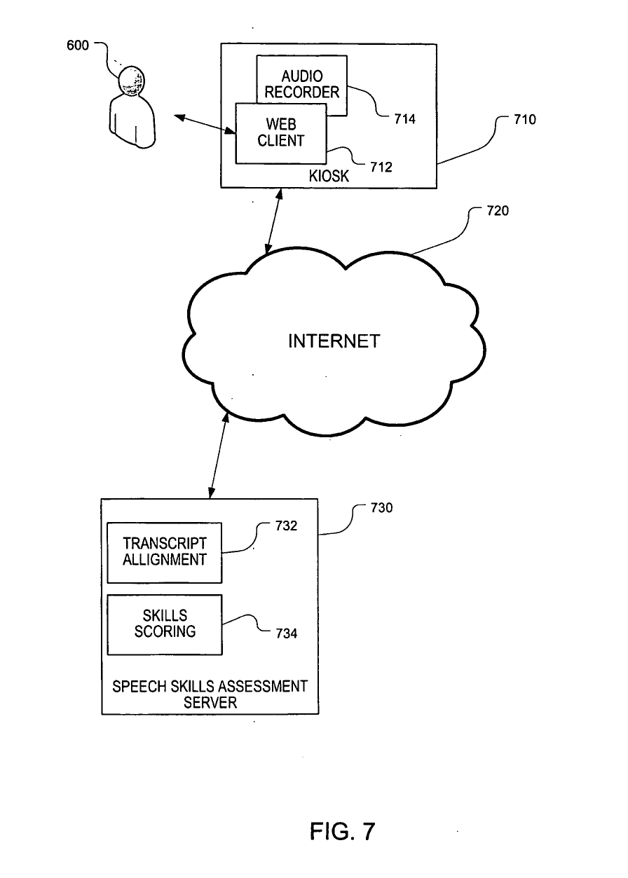

Referring to FIG. 7, in one example of a system, a kiosk 710 is hosted in a location where a job applicant 600 is applying for a job. For example, the kiosk is hosted at an employment agency. The kiosk includes a web client 712, which provides a graphical interface to the applicant. Associated with the web client is an audio recorder 714, which provides a means for storing the recording of the applicant's speech. The web client communicates data, including audio data, with a speech skills assessment server 730 over a data network such as the Internet 720. The server 730 hosts transcript alignment 732 and skills scoring 734 modules, which implement procedures described above. The audio data and the results of the skills assessment can then be accessed by remote applicant screening personnel, for example, in graphical form that show overall or detailed results for each of the job applicants (e.g., as shown in FIG. 5).

In some examples, the speech skills evaluation is performed repeatedly, for example, in an on-going testing mode. For example, an employee in a call center may be tested periodically, or at random, during their employment.

In some examples, rather than the user reading a presentation text, the speech that is evaluated corresponds to a scripted portion of an interaction. For example, a call center telephone agent may answer the telephone with a standard greeting, or may describe a product with a scripted description, and a corresponding portion of a logged telephone call is used for the speech skills assessment.

In some examples, the skills assessment is used for multiple languages with one user or in a non-native language for the user.

Embodiments of the approaches described above can be implemented in software, for example, in a stored program. The software can include instructions embodied on a computer-readable medium, such as on a magnetic or optical disk or on a network communication link. The instructions can include machine instructions, interpreter statements, scripts, high-level program language statements, or object code. Computer implemented embodiments can include client and server components, for example, with an interface being hosted in a client component and analysis components being hosted in a server component.

It is to be understood that the foregoing description is intended to illustrate and not to limit the scope of the invention, which is defined by the scope of the appended claims. Other embodiments are within the scope of the following claims.

What is claimed is:

1. An method comprising:
accepting a speech signal corresponding to some or all of a text;
determining an association of the speech signal to the text; and
using the determined association to compute a level of speech skills of a speaker of the speech signal.

2. The method of claim 1 further comprising:
presenting the text to the speaker.

3. The method of claim 1 wherein accepting the speech signal includes recording the speech signal.

4. The method of claim 1 wherein determining the association of the speech signal to the text includes identifying time associations of portions of the text with portions of the speech signal.

5. The method of claim 4 wherein the speech signal includes portions not associated with the text.

6. The method of claim 4 wherein the text includes portions not associated with the speech signal.

7. The method of claim 1 wherein using the determined association to compute the level of speech skill includes computing scores characterizing one or more of
(a) a match between words spoken in the speech signal and the text,
(b) pronunciation match between linguistic units spoken in the speech signal and corresponding portions of the text,
(c) fluency of the speech signal, and
(c) prosodic match.

8. The method of claim 1 wherein determining the association of the speech signal to the text includes applying an automated speech processing procedure to align at least some of the text with at least some of the speech signal, and using the determined association includes determining quantitative assessments associated with the speaker's level of speech skills based on the alignment of the text with the speech.

9. The method of claim 8 wherein determining the quantitative assessments includes determining a score pronunciation score and determining a fluency score for the speaker.

10. The method of claim 9 further comprising combining the determined quantitative assessments to form a speech skills score for the speaker.

11. A method for evaluating a job applicant comprising:
accepting application data from the job applicant;
eliciting speech corresponding to an associated text from the applicant;
automatically determining a level of speech skill based on the elicited speech and the associated text; and
storing data associated with the determined level of skill in association with the application data accepted from the job applicant.

12. A system for assessing a level of speech skills of a user, the system comprising:
an interface module for accepting a speech signal corresponding to a text;
an alignment module for determining an association of the speech signal to the text; and
an analysis module for using the determined association to assess a level of speech skill of a speaker of the speech signal.

13. The system of claim 12 wherein the interface module is configured to accept communication with a remote device in the proximity of the speaker over a communication network.

14. The method of claim 13 wherein the interface module is configured to communicate with a remote software component for prompting the speaker and accepting the speech signal from the speaker.

15. A job application system comprising:
an interface for accepting application data from the job applicant, and for eliciting speech corresponding to an associated text from the applicant;
a speech analysis component configured to determine a level of speech skill based on the elicited speech and the associated text; and
an application data storage for storing the determined level of skill in association with the application data accepted from the job applicant.
